(19) United States
(12) Patent Application Publication
(10) Pub. No.: US 2004/0267566 A1
(43) Pub. Date: Dec. 30, 2004

(54) Computer-based clinical knowledge system

(76) Inventors: Robert Gwathmey Badgett, San Antonio, TX (US); Richard Niederman, Newton, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/756,432

(22) Filed: Jan. 12, 2004

Related U.S. Application Data
(60) Provisional application No. 60/439,393, filed on Jan. 10, 2003.

(51) Int. Cl. G06F 7/00; G06F 17/60; G06F 17/30

(52) U.S. Cl. 705/2; 707/3

(57) ABSTRACT

A method of identifying an evidence-based answer to a clinical question is provided. The method is comprised of electronically searching a plurality of scientific publications to yield an answer. The answer comprises search results, at least 10% of said results comprise a randomized controlled trial. The method produces at least 10% of results of a broad search having an evidence level of at least 3. The method produces at least 10% of results of a focused search having an evidence level of at least 1. The method produces usefulness of search results is at least 10 points higher compared to a standard MEDLINE/PubMed search.

### CLAIM OF PRIORITY

This application claims priority to U.S. Provisional Application No. 60/439,393, filed Jan. 10, 2003, which is herein incorporated by reference.

### FIELD OF THE INVENTION

The invention relates generally to database search engines for computer systems and more specifically to searching medical databases.

### BACKGROUND OF THE INVENTION

Search engines often use keywords linked through Boolean logic to search text-based documents electronically. Users of these engines typically submit one or more search terms to the search engine in a format specified by the search engine. Boolean or keyword search queries can become extremely complex as the user adds more search terms and Boolean operators. Moreover, most search engines have complex syntax rules regarding how a Boolean or keyword search query, must be constructed. The search terms are sent to a server computer that includes the search engine. The search engine receives the search command, and then using it scans for these keywords through available data such as a database. Thereafter, the results of the scan are transmitted from the server computer back to the user's computer and displayed on the screen of the user's computer. For users to get accurate search results, therefore, they must remember the appropriate syntax rules and apply them in an effective manner.

### SUMMARY OF THE INVENTION

The invention provides a method of identifying an evidence-based answer to a clinical question by electronically searching a plurality of scientific publications to yield an answer. The answer contains search results, e.g., information that identifies one or more publications. Preferably, at least 10% of the results represent a report of a randomized controlled trial. More preferably, at least 20%, 30%, 40%, 50%, 75%, 90%, and up to 100% of the results represent a report of a randomized controlled trial. For example, at least 10% of the results of a broad search are characterized as having an evidence level of at least 3, and the results from a focused search are characterized as having an evidence level of at least 1, e.g., a level of 1a, 1b, or 1c. Further, the usefulness of the search results is at least 10 points higher compared to the usefulness of results obtained using a standard MEDLINE/PubMed search. Usefulness is defined as (validity×relevance)/work.

In another aspect, the invention provides a method of formulating a database search. The method includes prompting for search terms in any of a plurality of categories, prompting for selection of at least one relevant subject matter, automatically associating synonyms of received search terms, if any, with the received search terms, the synonyms being predetermined to be relevant to the associated search terms, and automatically associating search criteria and subject matter terms with received indicia, if any, of at least one desired subject matter.

Implementations of the invention may include one or more of the following features. The method can include combining the received search terms and the associated synonyms, if any, with the search criteria and the subject matter terms, if any. Combining can comprise associating the terms and the criteria through Boolean logic to form a search string. The method can also include analyzing the search string in association with characteristics of a searchable database to determine a URL associated with the searchable database corresponding to the search string.

Further implementations of the invention may include one or more of the following features. The categories can include a patient problem, intervention/treatment, comparison, and outcome. The at least one relevant subject matter can include clinical area and clinical issue. The method can further include prompting for selection of a desired search breadth. The method can include prompting for selection of a patient age limit as well.

Embodiments of the invention may provide one or more of the following advantages compared to earlier methods. The invention provides an intelligible method of searching databases with greater efficiency and ease. For example, a searchable database of substantial medical articles exists and is called MEDLINE/PubMed, which employs a search engine to conduct a search and recover documents that correspond to those requested by a searcher. The searcher uses a tutorial to understand Boolean operators or must know the MeSH (Medical Subject Headings) vocabulary, the specific language used by the National Library of Medicine to catalog articles, in order to construct an effective search. In some circumstances, if the search criteria are made broad, the search engine will often produce thousands of “hits”, many of which are of no interest to the searcher. If the criteria are made too narrow, there is a risk that relevant documents will be missed. In the medical field, this is of particular importance, as evidence-based clinical decision making is directly related to the presence of and access to all relevant clinical information and literature, often in the form of evidence collected from randomized controlled trials. Often, it is up to the user of the search engine to know the most up-to-date terms and language in order to achieve the maximum return on the applicable search, or recent clinical information may be overlooked. The method allows an inexperienced search operator to conduct sophisticated searches to yield highly useful and relevant publications pertaining to the target field of interest with ease, avoiding the necessities of searching MEDLINE as described.

### BRIEF DESCRIPTION OF THE FIGURES

FIG. 1 is a simplified block diagram of a computer system for implementing portions of the invention;

FIG. 2 illustrates a diagram of the web interface used in portions of the invention;

FIG. 3 illustrates a flow chart depicting the search method based on one embodiment of the present invention;

FIG. 4 illustrates a flow chart depicting the search engine of an embodiment of the present invention; and

FIG. 5 illustrates a flow chart depicting the search engine of an embodiment of the present invention.

### DETAILED DESCRIPTION OF PREFERRED EMBODIMENTS

The invention utilizes a search engine that searches a database of clinical dental information and, specifically, randomized controlled trials (RCT). The invention can also be used for other forms of searches such as in searching databases containing information other than that in the medical arena. Still other embodiments are within the scope of the invention.

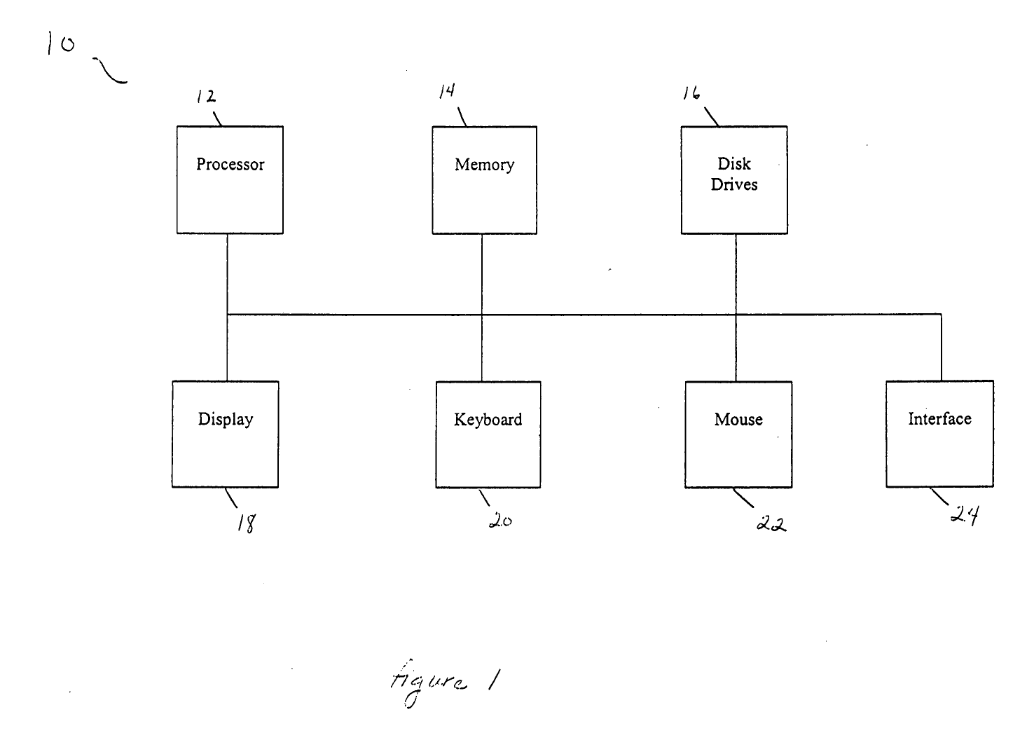

Referring to FIG. 1, a computer system 10 (e.g., a server) includes a processor 12, memory 14, disk drives 16, a display 18, a keyboard 20, a mouse 22, and an interface 24. The processor can be a personal computer central processing unit (CPU). The memory 14 includes random access memory (RAM) and/or read-only memory (ROM). The disk drives 16 include a hard-disk drive and can include floppy disk drives, a CD-ROM drive, DVD drives and/or a zip drive. The display 18 is configured to provide visual indicia of data entered into the computer or processed by the processor 12. The keyboard 20 and mouse 22 are configured for data entry and manipulation. Other data entry and/or data manipulation devices may be included. The interface 24 is configured to transfer data to and from the computer 10 and a network, and/or to and from any other desired device, that may contain a database, that is properly connected to the interface 24 (e.g., through a Local Area Network (LAN) or a Wide Area Network (WAN)). Other configurations of the computer 10 are possible, e.g., without the mouse 22, and/or including a touch-sensitive cursor control, etc. The components 12, 14, 16, 18, 20, 22 and 24 are connected by a bus.

When used in a LAN networking environment, a personal computer 10 is connected to the LAN through a network interface 24. When used in a WAN networking environment, the personal computer 10 typically includes a modem or other means for establishing communications over the WAN, such as the Internet. The modem, which may be internal or external, is connected to the system bus via a serial port interface 24. In a networked environment, program modules depicted relative to the personal computer 10, or portions thereof, may be stored in the remote memory storage device. The network connections shown are exemplary and other means of establishing a communications link may be used.

The computer system 10 can execute one or more software programs to process data in accordance with features described below. In particular, the disk drives 16 contain appropriate computer-readable and computer-executable software code instructions that can be read and executed by the processor 12 to perform below-described functions on data.

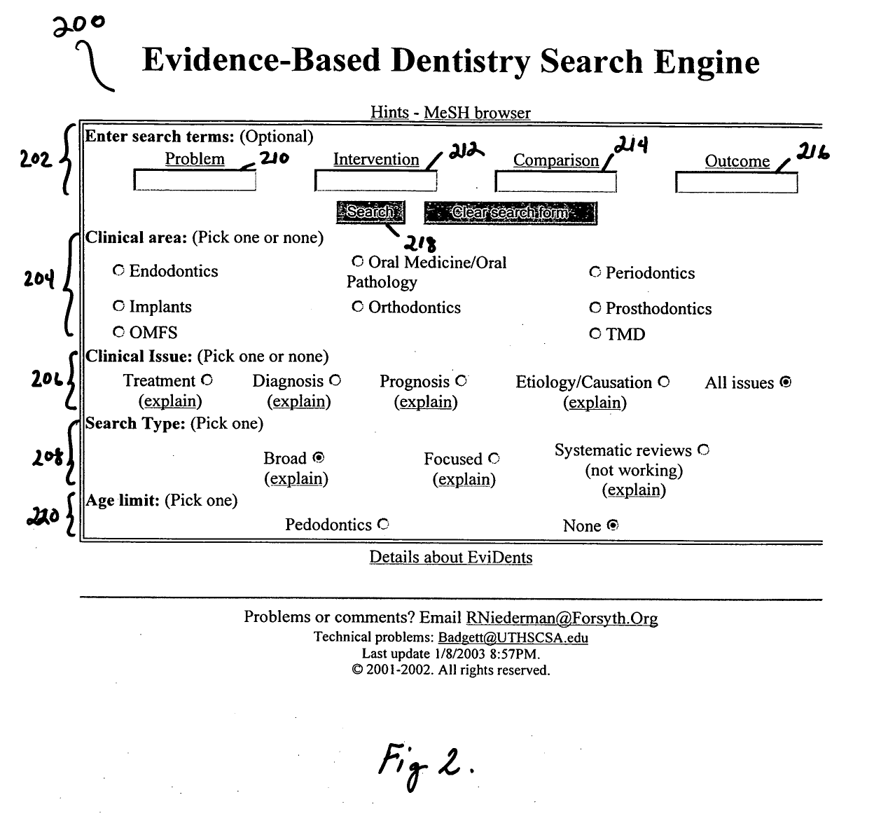

Here, the system 10 includes a software program that processes data to provide a search engine with a server for formulating a targeted search for clinical data relevant to dentistry and data evidencing results of randomized controlled trials. To formulate a proper search, the server uses search parameters entered by a user. Referring to FIG. 2, the system 10 is configured to provide a user interface 200 (e.g., a web interface) that includes subcategories to prompt the user to provide corresponding input to define the search. The web interface 200 includes the subcategories of search terms 202, clinical area 204, clinical issue 206, search type 208, and age limit 220. The user submits the desired search via a search button 218.

Each of the subcategories allows entry or selection of terms that can help to direct, e.g., broaden or narrow, the scope of the desired search. The subcategory 202 for search terms allows the user to enter, into corresponding fields, terms related to any of four applicable topics: a patient or problem 210, intervention/treatment 212, comparison 214, and outcome 216. These fields 210, 212, 214 and 216 are known as PICO terms. The user can use fields 210, 212, 214 and 216 to define the parameters of the clinical information that the user seeks. Alternatively, the user can identify a term to enter in the fields 210, 212, 214, and 216 via selection of a MeSH browser link that has choice terms for each of the fields 210, 212, 214 and 216, given as examples. The user may enter search terms in as many or as few of the fields 210, 212, 214 and 216 as appropriate for the information the user seeks. The user may also select a clinical area 204 from a list of choices including, but not limited to, endodontics, implants, OMFS (oral and maxillofacial surgery), oral medicine/oral pathology, orthodontics, pedodontics, periodontics, prosthodontics and TMD (tempero-mandibular joint disorders). Additionally, the user may target the search to the clinical issue 206 with which there is most concern, such as treatment, diagnosis, prognosis, and/or etiology/causation. The user can, alternatively, choose more than one issue to search, or the user can search for all issues in the clinical issue subcategory 206. The search type subcategory 208 allows a selection for a broad search or a focused search based on the search terms, clinical area and clinical issues of interest. Alternatively, a user can select a systematic review search type that allows for review of only particular types of articles, for example. The age limit subcategory 220 allows the user to limit the search to dental information applicable to children, i.e., pedodontics, or not to limit the patient age.

The user is not required to choose criteria in each of the subcategories, and is otherwise not limited to choosing only a single field of interest in each of the subcategories 202, 204 and 206. With desired information in each of the fields, the user selects (e.g., clicks) the search button 218 to submit the search.

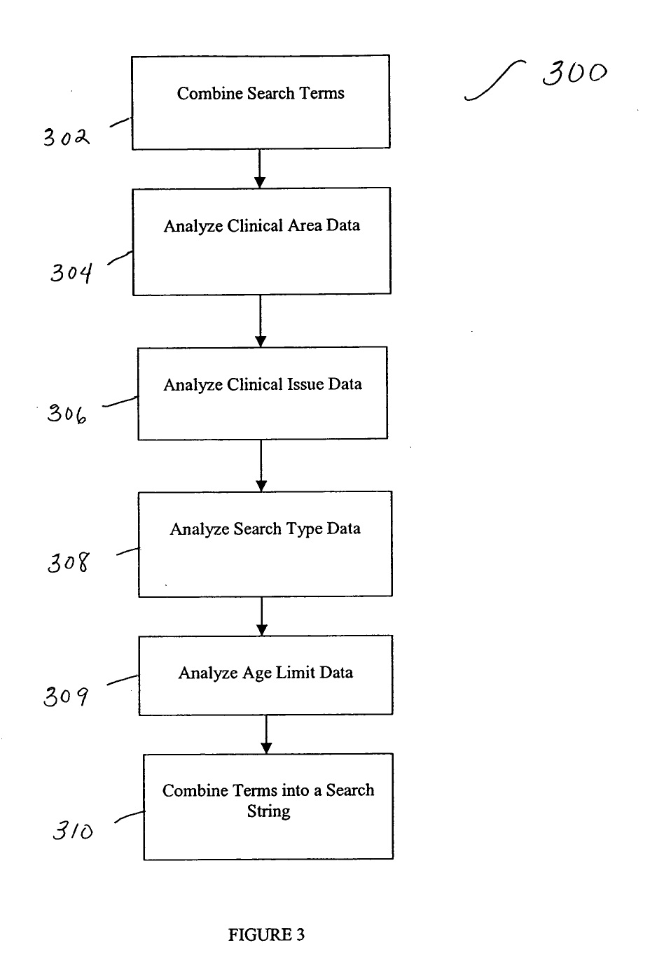

Referring to FIG. 3, with further reference to FIGS. 1-2, the system 10 is configured to perform a process 300 of formulating a clinically-relevant search based upon the data entered by the user using the interface 200. The process 300 includes the stages shown, although the process 300 may be altered, e.g., by having stages added, deleted, or moved relative to the stages shown.

The system 10 combines the search terms entered by the user via the interface 200. At stage 302, the system 10 links each term entered in the individual fields 210, 212, 214, and 216 of search terms in the subcategory 202 with a Boolean AND operation for each field. The system 10 then combines the fields 210, 212, 214, and 216, and the collection of terms from fields 204, 206, 208 and 220 with a Boolean AND operation. Each of the terms in the fields 210, 212, 214 and 216 is recoded by the system 10 as a word term or a MeSH term (Medical Subject Headings term).

At stage 304, the system 10 analyzes the clinical area subcategory data 204 entered by the user. One, or more than one, e.g., 2, 5, or 8 clinical areas can be chosen from the clinical area subcategory 204. For each clinical area field selected, the system 10 selects from memory 14 synonyms and other terms previously experimentally determined to be useful for searching of the selected field. The synonyms and other useful terms are combined in a desired fashion through Boolean logic, e.g., by inserting linking terms such as AND, OR, ANDNOT, etc., as has been determined experimentally to yield relevant results.

Preferably, synonyms and other useful vocabulary and search strategies are predetermined or experimentally determined through trial and error. Determining synonyms and vocabulary preferably involves a manual review of MEDLINE/PubMed to identify the Medical Subject Heading terms and the subheadings that describe each of the dental disciplines. In addition to the vocabulary in MEDLINE/PubMed, discipline-specific textbooks reveal additional or alternative terms within the dental field, such as a review of the glossaries of textbooks used in graduate programs of the Harvard School of Dental Medicine. A working vocabulary results, and the working vocabulary is used in the searching of the selected field or fields.

The language derived for use in a search strategy thus results from a manual review of MEDLINE/PubMed and textbooks. For purposes of this paragraph only, the words FOCUS, EXPLODE and ADJACENT refer to the current use of these words to describe functions in PubMed searching. Terms determined to be of use in the manual review are searched for separately in MEDLINE/PubMed, both as MeSH headings and as keywords, and compared against the working search to determine if there are any relevant articles in the specified discipline. Search commands are applied to the subject headings as well. For example, the EXPLODE function is applied to subject headings for the most comprehensive search. EXPLODE identifies every term logically beneath a categorical level, so that all conceptually related subtopics are identified and can be included in a search. The FOCUS function is applied to broader topics within a search to retrieve only articles where the topic of inquiry is the only topic of concern. In other words, FOCUS determines the primary focus of an article and ranks it accordingly. Search strategies derived using this function are preferably used when the user requests a narrow, or specific, search. Additionally, the ADJACENT function can be used in developing the search to identify articles that are responsive to the search, but where the search terms appear in a non-conventional order. A keyword search is also applied after each of the EXPLODE, FOCUS, and ADJACENT functions in order to capture related topics or terms. This process for deriving a language is also used to update the search language contained in the memory 14 of system 10. The update process can be limited to identify the most recent or most relevant publications by limiting the time frame (e.g., the publication date of the reference).

At stage 306, the system 10 analyzes the clinical issue data 206 entered by the user. The clinical issue data 206 is combined with the type of search data 208 to trigger a search of the memory 14 of system 10 for synonyms and other terms previously determined by Haynes et al. [http://www.ncbi.nlm.nih.gov/entrez/query.fcgi?cmd=Retrieve&db=PubMed&list_uids=95153434] to be useful for searching of the selected issue. To accomplish this, the system 10 employs methodologic search filters and applies the filters to the search terms. Search strategies are directed to the sensitivity, specificity, accuracy and precision necessary to appropriately respond to the search request. These search strategies are used to identify into which of four clinical categories of information the search terms fall: etiology, diagnosis, therapy and prognosis. The synonyms and other useful terms are combined in a desired fashion through Boolean logic as has been previously determined experimentally by Haynes et al. (see above) to yield relevant results. The system 10 also analyzes the search type data 208 entered by the user. If the user selected a broad or sensitive search, then preferably a large number of relevant articles but also some irrelevant ones will be retrieved. If the user selected a focused or specific search, then preferably a small number of the most relevant articles are identified. If the user selects a systematic review, then preferably articles identified as pertaining to a specific clinical issue are retrieved.

At stage 309, the system 10 analyzes the age parameter data 220 entered by the user, and through Boolean logic, the age parameters desired are added to the search string to further define the search. For example, a user wishing to limit the search to issues in pedodontics may do so by appropriately selecting that field in the age limit subcategory 309.

At stage 310, the combination of terms determined from the user's selections and analyzed according to stages 302, 304, 306, 308 and 309 are combined into a search string. The terms determined from the search term entries 202, the selected clinical area(s) 204, the selected clinical issue(s) 206, the search type 208, and the age limit 220 are combined in a Boolean AND. The search string is manipulated by the system 10 as appropriate into a search of a database to be searched, e.g., into a URL for a MEDLINE/PubMed search. This is done using known relationships between Boolean logic search strings and URLs of the appropriate database. The system 10 conducts a series of evaluations, based on different search strings, and each evaluation stratifies the information retrieved from the search so that the most accurate results are returned to the user depending on the specified search parameters.

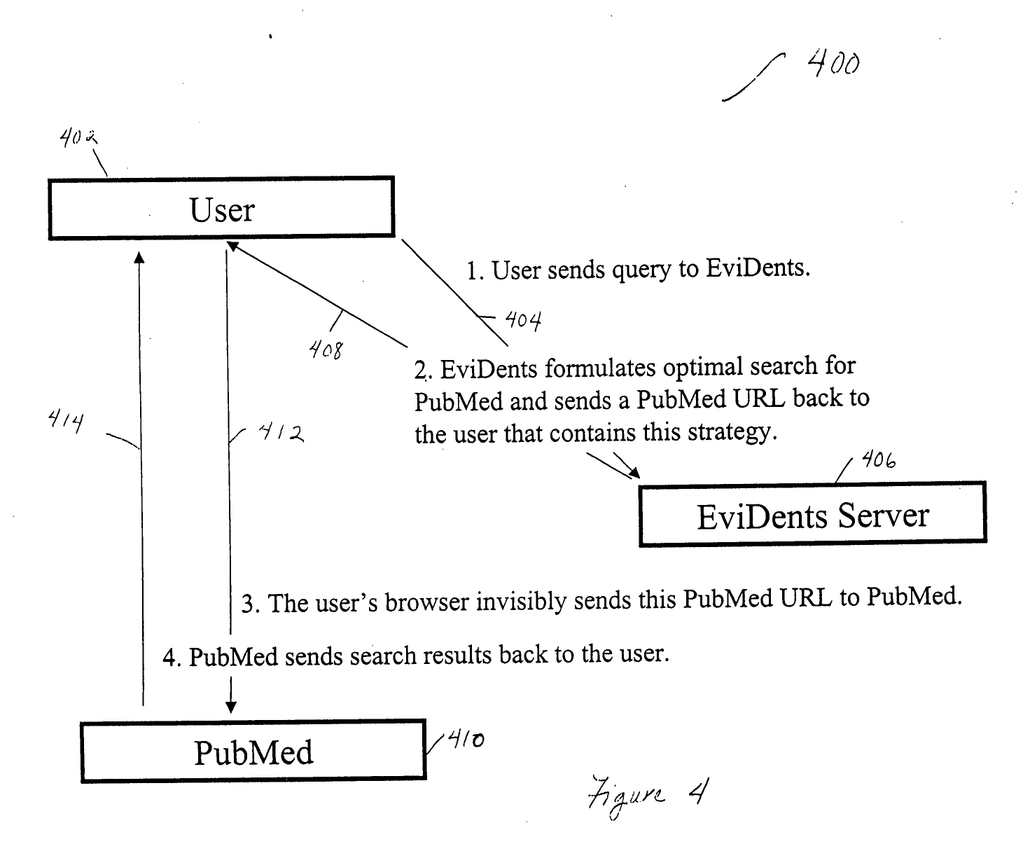

FIG. 4 depicts a process 400 according to which the search engine is employed. In the process 400, a user 402, a server 406 and a database 410, such as the MEDLINE/PubMed database, interact as shown. The user 402 sends 404 a query to the server 406. Referring also to FIG. 3, the server 406 formulates optimal search terms to create a search string and from that a search, here a URL, that can be submitted to MEDLINE/PubMed. The server 406 sends 408 the user 402 the MEDLINE/PubMed URL that represents the newly organized search string. The user 402 receives the URL and the user's browser sends 412 the MEDLINE/PubMed URL to the MEDLINE/PubMed database 410. Formulating the search and sending the URL to the user occurs transparently to the user. The MEDLINE/PubMed database 410, having received the URL from the user 402, performs the requested search and returns 414 to the user 402 the search results based on the strategic search that was formulated by the system 10. The process shown is exemplary, and not limiting, as other processes would be acceptable.

The search engine automatically examines the search results produced by the MEDLINE/PubMed database 410 before sending the results to the user 402. If less than optimal results are received from the MEDLINE/PubMed database 410 from a focused search (e.g., a focused search results in 0 articles), the search engine will automatically re-query MEDLINE/PubMed to instead produce results from a broad search rather than a focused search. The search engine can simultaneously execute a broad search and a focused search and present the results of the broad search if the focused search results in no citations to applicable articles.

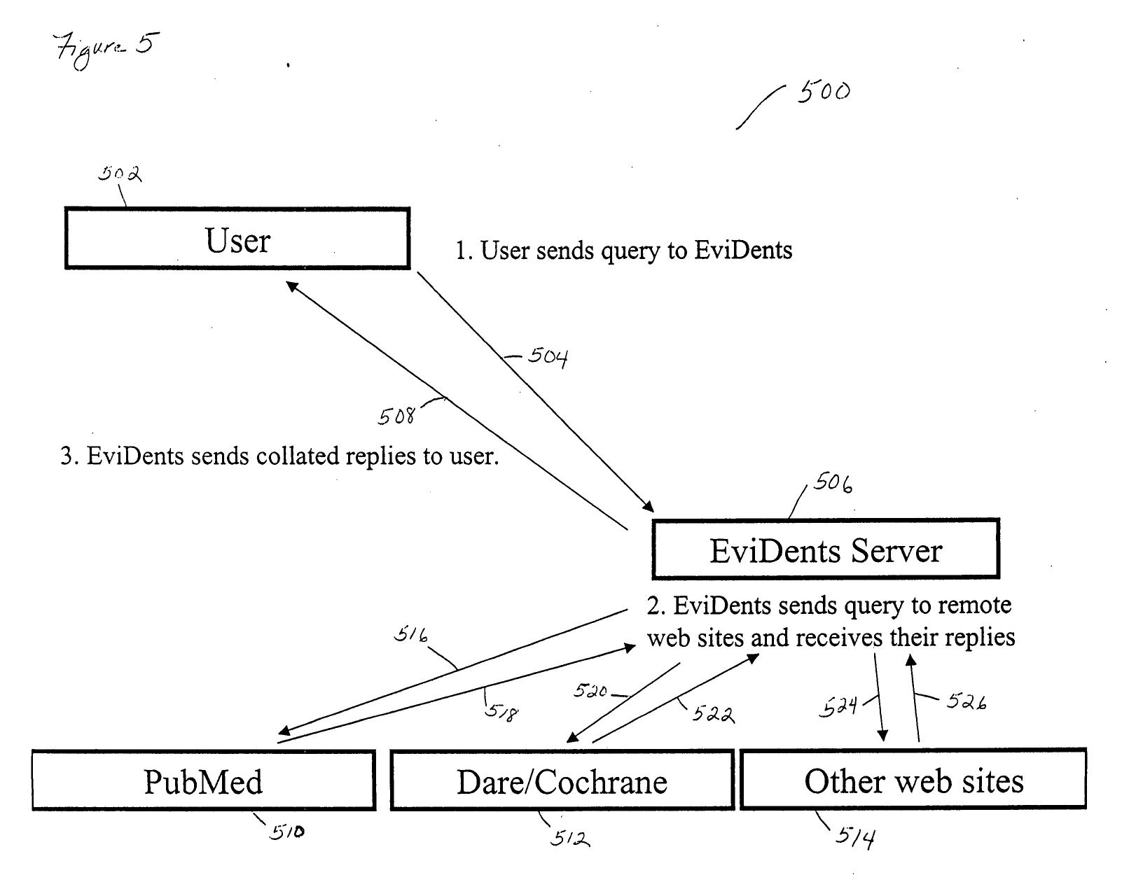

An alternative method of processing data using the server is described with reference to FIG. 5. In this process, a user 502, a server 506, and remote databases 510, 512 and 514 interact. The user 502 sends a query 504 to the server 506, and the server 506 works to formulate a search string based on the requests from the user. When a URL is formulated that contains the search, the server 506 sends the URL to the remote databases 510, 512, 514 depicted by routes 516, 520, and 524. The remote databases 510, 512, 514 may include the MEDLINE/PubMed database 510, the Dare/Cochrane database 512, as well as other websites 514. The remote databases 510, 512, 514 return search results to the server 506, via routes depicted as 518, 522, and 526. The server 506 collates the search results from all of the applicable databases 510, 512, 514 and stratifies the responses by breadth of discussion. The server 506 then sends 508 the collated reply to the user 502. The communication between the server 506 and the remote databases 510, 512, 514 occurs transparently to the user 502, who receives the search results satisfying the original request.

Evidence-Based Search Strategy

To implement an evidence-based search using the search engine and search strategy of the invention, a collection of clinical and research reports must be available to be searched. To determine the availability of clinical information, a search strategy was developed and implemented in MEDLINE/PubMed. Studies of MEDLINE/PubMed were conducted to gather this information, such as studies used by the United States National Academy of Sciences for evaluating research programs and for evaluating clinical progress in a number of fields.

MeSH terms related to oral health were first identified. Three validated search strategies derived from Clinical Evidence were used on MEDLINE/PubMed, as was the publication type “randomized controlled trials” used by MEDLINE/PubMed. Sensitive searches retrieved the largest number of relevant articles and specific searches retrieved a small number of the most relevant articles. Thus, four different search strategies were employed: maximum sensitive, sensitive, RCT, and specific. For example, using these strategies, the total number of oral health randomized controlled trials published between 1990 and 2000 identified on MEDLINE/PubMed was between 1000 and 12,000.

The oral health literature was subdivided into dental disciplines for better understanding of the dynamics of the identified literature. The eight disciplines identified were endodontics, implants, oral and maxillofacial surgery, oral medicine/oral radiology, orthodontics, periodontics, restorative, and tempero-mandibular joint disorders. Articles about humans were identified for each of these disciplines. In addition, MeSH terms that were included within the MEDLINE/PubMed search strategy were examined for completeness. The dental discipline specific searches were combined with the previous search strategies for identifying RCT in each discipline.

Validated sensitive and specific methodologic filters were applied to each of the dental disciplines to identify four categories of clinical information: etiology, diagnosis, therapy and prognosis.

Examples of how the search engine is used to identify more focused articles addressing endodontic issues are provided. The results derive from use of the working prototype found at, for example, http://medinformatics.uthscsa.edu/EviDents/. The following examples do not limit the scope of the invention described in the claims.

Usefulness

The invention provides a method for identifying clinically useful publications. The quality or usefulness of search results are at least 2% more useful than conventional methods (e.g., MEDLINE).

The following equation defines usefulness of a search for a clinician:

Usefulness=(validity×relevance)/work

Grandage et al., When Less Is More: A Practical Approach to Searching for Evidence-Based Answers, J. Med. Lib. Assoc. 2002, 90, 298-304. Validity is defined as the scientific rigor or level of excellence. A value for validity is presented in evidence levels 1 to 3, found at www.eboncall.co.uk/content/levels.html. For example, evidence level 1 is randomized controlled trials, evidence level -2 represents cohort studies, and evidence level 3 represents case-control studies. Relevance refers to whether a reference directly evaluates the effectiveness of care on patient outcomes. Work, or time, is the difficulty in obtaining the information.

Usefulness is evaluated as follows. Ten individuals, e.g., dentists or other medical practitioners, are randomly assigned to one of two groups: the MEDLNE/PubMed group or the Evidence-Based Search Strategy Group, which employs the inventive strategy. The individuals are also randomly provided with a clinical question. For example, one of two simple endodontic clinical scenarios are provided to the searcher. Each scenario ends with a clinical question framed in a format employing PICO. Instruction in evidence-based dentistry, structuring questions in PICO formats, or searching either of MEDLINE/PubMed or the inventive search engine is not provided. The individuals conduct a search to answer the clinical question, and searching is done in 30 minutes or less. Each individual thereafter searches using the alternate search engine, and the searching is once again completed in 30 minutes or less.

Two or more examiners evaluate the search results and use the equation, shown above, to determine usefulness. For untrained individuals using the inventive search engine, the validity and the relevance scores are 20 points higher than those done by the same untrained individual using MEDLINE/PubMed. Further, the time required to obtain these results is 10 minutes less when using the inventive search engine. Table 1 illustrates these results.

TABLE 1

| | Validity | Relevance | Time | Usefulness |
|---|---|---|---|---|
| Inventive | 50 | 50 | 15 | 166 |
| Search Engine | | | | |
| MEDLINE | 30 | 30 | 25 | 36 |
| Difference | 20 | 20 | 10 | 130 |

The inventive search engine produces evidence-based clinical publications that are at least 1% more useful than those produced using the MEDLINE/PubMed search engine. Generally, usefulness of resulting publications is increased by up to 90% when the inventive search engine is employed.

### EXAMPLE 1

A search was conducted to identify all citations to articles on human endodontics. According to one search method, the user selected endodontics in the clinical area subcategory 204 and broad for the search type subcategory 208. The MEDLINE/PubMed database returned a result of 12,699 articles relating to human endodontics.

### EXAMPLE 2

The user wished to identify all articles relating to human endodontic treatment, diagnosis, prognosis, and etiology. To achieve the proper search, the user selected endodontics in the clinical area subcategory 204, the clinical issue 206 (e.g., one of treatment, diagnosis, prognosis or etiology), and the search type 208, either broad or focused. The resulting number of articles cited is presented in Table 2.

TABLE 2

| | Treatment | Diagnosis | Prognosis | Etiology |
|---|---|---|---|---|
| Broad | 4045 | 2398 | 1059 | 854 |
| Focused | 56 | 33 | 266 | 20 |

### EXAMPLE 3

Example 3 sought to identify all articles relating to human endodontic abscess. The user entered “abscess” as the term in field 210 of the search terms subcategory 202, where field 210 calls for the patient or problem term. The user selected endodontics in the clinical area subcategory 204 and the search type 208. The result was 1066 articles on MEDLINE/PubMed relating the human endodontic abscess, as shown in Table 3.

### EXAMPLE 4

To accomplish a search for all articles relating to treating human endodontic abscess, the user entered “abscess” as the term in field 210 of the search terms subcategory 202, where field 210 calls for the patient or problem term. The user selected endodontics in the clinical area subcategory 204, treatment in the clinical issue subcategory 206 and the search type 208. Results of the search are displayed in Table 3.

### EXAMPLE 5

To further refine the search, example 5 identifies a search for all articles relating to treating human endodontic abscess with antibiotics. The user enters “abscess” as the term in field 210 of the search terms subcategory 202, where field 210 calls for the patient or problem term, and “antibiotics” as the term in field 212 requesting intervention terms. The user selected endodontics in the clinical area subcategory 204, treatment in the clinical issue subcategory 206 and the search type 208. Results are presented in Table 3.

### EXAMPLE 6

Still further detail was achieved to accomplish a search for articles relating to treating human endodontic abscess with antibiotics for swelling. The user entered “abscess” as the term in field 210 of the search terms subcategory 202, where field 210 calls for the patient or problem term, “antibiotics” as the term in field 212 requesting intervention terms, and “swelling” as the term in field 216, the field for entry of the outcome term. The user then selected endodontics in the clinical area subcategory 204, treatment in the clinical issue subcategory 206 and the search type 208. Results are presented in Table 3.

TABLE 3

| | | | | Abscess, |
|---|---|---|---|---|
| | | | Abscess, | Treatment, |
| | | Abscess and | Treatment, and | Antibiotic, and |
| | Abscess | Treatment | Antibiotic | Swelling |
| Broad | 1066 | 331 | 147 | 8 |
| Focused | — | 8 | 4 | 3 |

Thus, the data presented in Tables 2 and 3 illustrate the ability of the user to refine a search sent to the search engine by adding terms to fields 210, 212, 214 and 216. By adding terms in the provided fields, the user decreased the number of articles from 4045 to 8 appropriate articles. The user should enter terms appropriate to the information the user seeks, but need not enter the focused terms using Boolean operators or have knowledge of the MeSH vocabulary.

For comparative purposes, a search string for use in MEDLINE/PubMed is presented below and illustrates the simplicity of the aforementioned search method. Searching MEDLINE/PubMed directly conducting a broad search for abscess, treatment, antibiotic, and swelling to retrieve the 8 applicable articles that were found using the inventive search method (see Table 2) requires the user to enter the following search string:

(abscess[MeSH] AND antibiotic AND
swelling[MeSH] OR (abscess[Word] AND antibiotic
AND swelling[Word] AND ((((randomized controlled
trial [PTYP]) OR drug therapy [SH]) OR therapeutic
use[SH]) OR random* [Word]) AND
((endodontics[MH:NOEXP] OR apicoectomy[MH:NOEXP] OR
pulpectomy[MH:NOEXP] OR pulpotomy[MH:NOEXP] OR
root canal therapy[MAJOR] OR root canal filling
materials[MESH] OR dental pulp test[MAJOR:NOEXP] OR
dental pulp diseases[MESH] OR periapical abscess[MH:NOEXP]
AND Human[MESH])

Thus, the search method described above is an intelligible method of searching PubMed with greater efficiency and ease. The method allows an inexperienced search operator to conduct sophisticated searches to yield highly useful and relevant publications pertaining to the target field of interest.

Although the examples above are directed to use of the inventive search engine to retrieve information related to dentistry and oral health, the search engine and search strategy are equally effective in searching a multitude of other disease categories and medical disciplines. For example, MEDLINE disease categories for which the inventive search engine is useful include, but are not limited to: animal diseases, bacterial infections and mycoses, cardiovascular diseases, congenital, hereditary, and neonatal diseases and abnormalities, digestive system diseases, disorders of environmental origin, endocrine diseases, eye diseases, female genital diseases and pregnancy complications, hemic and lymphatic diseases, immunologic diseases, musculoskeletal diseases, neoplasms, nervous system diseases, nutritional and metabolic diseases, otorhinolaryngologic diseases, parasitic diseases, pathological conditions, signs and symptoms, respiratory tract diseases, skin and connective tissue diseases, stomatognathic diseases, urologic and male genital diseases, and virus diseases.

Medical disciplines for which the inventive search engine is useful include, but are not limited to: adolescent medicine, andrology, behavioral medicine, clinical medicine including evidence-based medicine, community medicine, epidemiology including molecular epidemiology and pharmacoepidemiology, medical genetics, geriatrics, herbal medicine, military medicine, naval medicine including submarine medicine, osteopathic medicine, psychiatry, including adolescent, biological, child, community, forensic, geriatric and military psychiatry, social medicine, medical specialties, including allergy and immunology, anesthesiology, dermatology, emergency medicine, family practice, forensic medicine, hospitalists, internal medicine, neurology, pathology, pediatrics, physical medicine, preventive medicine, psychiatry, radiology, reproductive medicine, and venereology, surgical specialties, including colorectal surgery, gynecology, neurosurgery, obstetrics, ophthamology, orthopedics, otolaryngology, surgery, plastic surgery, thoracic surgery, and urology, sports medicine, telemedicine, including remote consultation, telepathology, and teleradiology, traumatology, and tropical medicine.

Other Embodiments

The embodiments of the invention described above are four subcategories that include search terms, clinical area, clinical issue, and search type. Other configurations are acceptable, such as configurations that include additional search subcategories, such as date ranges or cross-disciplinary information.

The embodiments of the invention described above are one-time searches by users by accessing the web interface. Other configurations are acceptable, such as configurations that include a screen login page where a secure account can be created on the system so that searches can be saved.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method of identifying an evidence-based answer to a clinical question, comprising electronically searching a plurality of scientific publications to yield an answer, wherein said answer comprises search results, at least 10% of said results comprising a randomized controlled trial.

2. The method of claim 1, wherein at least 10% of said results of a broad search comprise an evidence level of 3 or above.

3. The method of claim 1, wherein at least 10% of said results of a focused search comprise an evidence level of at least 1.

4. The method of claim 1, wherein the usefulness of said search results is at least 10 points higher compared to a standard MEDLINE/PubMed search.

5. A method of formulating a database search, the method comprising:
prompting for search terms in any of a plurality of categories;
prompting for selection of at least one relevant subject matter;
automatically associating synonyms of received search terms, if any, with the received search terms, the synonyms being predetermined to be relevant to the associated search terms; and
automatically associating search criteria and subject matter terms with received indicia, if any, of at least one desired subject matter.

6. The method of claim 5 further comprising combining the received search terms and the associated synonyms, if any, with the search criteria and the subject matter terms, if any.

7. The method of claim 6 wherein the combining comprises associating the terms and the criteria through Boolean logic to form a search string.

8. The method of claim 7 further comprising analyzing the search string in association with characteristics of a searchable database to determine a URL associated with the searchable database corresponding to the search string.

9. The method of claim 5 wherein the categories include a patient problem, intervention/treatment, comparison, and outcome.

10. The method of claim 5 wherein the at least one relevant subject matter includes clinical area.

11. The method of claim 5 wherein the at least one relevant subject matter includes a clinical issue.

12. The method of claim 5 further comprising prompting for selection of a desired search breadth.

13. The method of claim 5 further comprising prompting for selection of a desired patient age limit.

14. A method of identifying an evidence-based answer to a clinical question using a search engine, the method comprising:
combining search terms and criteria entered by a user of the search engine to define a desired search;
selecting synonyms for the search terms and combining the synonyms with the search terms;
searching a plurality of publications associated with the combination of search terms and synonyms to achieve a desired outcome; and
returning to the user at least one randomized controlled trial pertinent to the desired search as a search result.

15. The method of claim 14 wherein the search terms include one of a problem, an intervention/treatment, a comparison, and an outcome.

16. The method of claim 14 wherein the combining comprises associating the search terms and the criteria through Boolean logic to form a search string.

17. The method of claim 14 wherein the criteria include at least one of a clinical area and a clinical issue.

18. The method of claim 14 further comprising prompting for selection of a desired search breadth.

19. The method of claim 14 further comprising prompting for selection of a desired patient age limit.
